(19) United States
(12) Patent Application Publication
(10) Pub. No.: US 2019/0263707 A1
(43) Pub. Date: Aug. 29, 2019

(54) METHOD FOR PRODUCING GLASS BOTTLES WITH A LOW DELAMINATION TENDENCY UNDER THE EFFECT OF A PURGE GAS FLOW

(71) Applicant: Schott AG, Mainz (DE)

(72) Inventors: Robert Frost, Grub AR (CH); Ulrich Lange, Mainz (DE); Doris Moseler, Budenheim (DE)

(73) Assignee: Schott AG, Mainz (DE)

(21) Appl. No.: 16/412,707

(22) Filed: May 15, 2019

Related U.S. Application Data
(63) Continuation of application No. PCT/EP2017/077114, filed on Oct. 24, 2017.

(30) Foreign Application Priority Data
Nov. 16, 2016 (DE) 10 2016 122 061.2

(51) Int. Cl. C03B 23/09; C03C 23/00; A61J 1/06

(52) U.S. Cl. CPC C03B 23/09; A61J 1/065; C03C 23/0075

(57) ABSTRACT

In a method for producing glass bottles having a flat base and an opposite filling opening, the base of the glass bottles is further formed at a plurality of processing positions. During the entire further forming of the base, with the aid of a purge gas which by way of the filling opening of the glass bottle flows in or out in a centric manner and flows out or in in an eccentric manner, a purge gas flow is generated in the interior of the glass bottle in order for delamination effects to be reduced. A tube or a nozzle serves for blowing in or suctioning out the purge gas. Various geometries and arrangements of the tube or of the nozzle are disclosed. A multiplicity of geometric constellations of the tube diameters and various mass flow settings are disclosed.

### CROSS REFERENCE TO RELATED APPLICATIONS

This is a continuation of PCT application No. PCT/EP2017/077114, entitled “METHOD FOR PRODUCING GLASS BOTTLES WITH A LOW DELAMINATION TENDENCY UNDER THE EFFECT OF A PURGE GAS FLOW”, filed Oct. 24, 2017, which is incorporated herein by reference.

### BACKGROUND OF THE INVENTION

### 1. Field of the Invention

The invention relates to a method for producing glass bottles, and in particular to a method for producing glass bottles with a low delamination tendency under controlled conditions.

### 2. Description of the Related Art

On account of the ever-increasing quality and safety standards, glass bottles of maximum quality and finish are nowadays required in medical, pharmaceutical, and chemical facilities. It is required in particular that glass bottles are to have a very high chemical resistance so as to enable an ideally long storage of the content of said glass bottles without any diffusion or unintentional chemical reaction. However, glass bottles having this property cannot be produced (or at least not to the desired quality) by way of conventional production methods which are known, for example, from U.S. Pat. Nos. 1,700,326 and 2,193,376.

Only modern production methods enable the production of glass bottles having the desired chemical resistance. Two fundamental methods for producing glass bottles having a very high chemical resistance exist currently, specifically the subsequent coating of the internal walls (with silicon compounds, for example), or the direct production of glass bottles having a homogenous surface by special production methods.

For the direct production of the desired glass containers, the device known from European Patent Application EP 2 818 454 A1 can be resorted to. This device comprises a so-called mother machine and a downstream so-called base machine. In the production process, a glass tube is first attached to a holding unit of the mother machine, said glass tube by rotating the mother machine being moved to the various processing positions so as to be pre-processed. Thereafter, a locally heated end of a glass tube is severed in a severing process, and the glass bottles which are configured therein and which have a closed base are transferred to a holding unit of the downstream base machine, where the bases of the glass bottles are further processed at various processing positions of the base machine. Various steps for suitably forming the glass bottle base are performed at the processing positions of the base machine. An ideally flat glass bottle base which during the process, due to the prevailing high temperatures, has a comparatively low viscosity is generated herein, in particular by various hot-shaping processes at temperatures at which the glass is deformable and by the rapid rotation of the glass bottles about the longitudinal axis thereof. In order for the glass bottle base not to collapse as a result, a suitable counter pressure is generated in the interior of the glass bottle by a gas that is briefly blown thereinto in order for the base to be stabilized. However, no continuous gas flow is used to this end. Rather, a gas-pressure impulse is used in order to build up a substantially static counter pressure in the interior of the glass bottle. Practically no gas flows out of the interior of the glass bottle again during the further processing of the base of a glass bottle. In the following processing steps, the glass bottle base, for the further forming thereof, is then pressed into a further die mold and subsequently cooled.

In order for the back pressure to be configured in the interior of the glass bottle, the filling opening across substantially the entire cross section thereof is briefly blown with a gas by a tube or a nozzle, wherein the tube or the nozzle is disposed at a comparatively large spacing from the filling opening and in particular outside the glass bottle, so as to avoid any further complexity in terms of instrumentation, for example for a vertical adjustment of the tube or the nozzle, respectively. The overall process conditions herein can be controlled only with difficulty, this leading to irregularities in the production of the glass bottles.

In the case of the aforementioned production methods, alkali borates, sodium, and the like evaporate from the hot glass by virtue of the very high temperatures prevailing in the region of the base, said vapors precipitating immediately again on cooler regions of the glass bottles, in particular in an annular zone at a certain spacing from the bottle base. This phenomenon in the context of borosilicate glasses is known under the term delamination tendency and makes it difficult for a constant optimum quality of the glass bottles to be guaranteed. In particular, the stoichiometric composition of the glass is also modified in the hot region close to the base of the glass bottle. On account of the later cooling of the glass bottle, a phase separation of the surface layer in the region of the base of a glass bottle is created as a result, said phase separation potentially having a further negative effect in terms of the chemical resistance of the glass bottle. By virtue of the partially non-controlled conditions during the hot-shaping processes, this leads to further irregularities in the production of the glass bottles.

In the production of glass bottles by the aforementioned production method, various machine parameters can be set and modified manually by the machine technician, so as to achieve and maintain both the desired geometric specifications as well as the desired surface specifications of the glass bottles. However, the influence of said machine parameters on the delamination tendency is largely unknown to date.

### SUMMARY OF THE INVENTION

Exemplary embodiments provided in accordance with the present invention refine an improved method for producing glass bottles, in particular glass bottles from borosilicate glass, wherein glass bottles of consistent and high quality which have a significantly reduced delamination tendency are to be produced in a controlled manner by the method, wherein the delamination tendency is in particular not to exceed a maximum value so as to enable a consistent, high quality of the glass bottles, that is to say without any rogue bottles in terms of quality being present.

In some exemplary embodiments provided according to the present invention, a method for producing glass bottles (vials) having a flat base and an opposite filling opening is provided. The method comprises the following steps: locally heating one end of a glass tube; configuring a flange or a rolled rim, having the filling opening at the locally heated end of the glass tube; severing the locally heated end of the glass tube while configuring a glass bottle having a closed base; and further forming of the base of the glass bottle. The glass bottle being configured herein, after the severing of the locally heated end of the glass tube from the glass tube, is held upside down. During the further forming of the base of the glass bottle at the prevailing comparatively high temperatures, with the aid of a purge gas the internal volume of the glass bottle is purged so as to purge alkali borates and the like from the internal volume of the glass bottle. The purge gas in the further forming of the base of the glass bottle by way of the filling opening flows in or out in a centric manner and flows out or in in an eccentric manner, so that a purge gas flow is generated in the interior of the glass bottle.

A laminar purge gas flow is generated according to the invention in the interior of the glass bottles by way of the purge gas which can in particular be air, an inert gas such as, for example, nitrogen, or a rare gas, the purge gas flow being conditioned in such a manner that the entering proportion of the purge gas flow according to the invention does not interact (or if at all interacts to a negligible extent) with the exiting proportion of the purge gas flow, such that the exiting proportion of the purge gas flow can leave the glass bottle again without any resistance and without any substantial turbulences. In particular, no non-linear flows, that is to say turbulences, are created according to the invention in the interior of the glass bottle, on account of which the overall production process is readily controllable and leads to reproducible results.

In the provision of the purge gas according to the invention, a flow-conducting structure can in particular be dispensed with, since the proportions of the purge gas flowing in a counter-directed manner do indeed contact one another directly, but do not configure any turbulences. However, the use of a flow-conducting structure according to further embodiments provided according to the invention is not fundamentally precluded, as is explained in more detail herein.

The purge gas flow mentioned previously results in the alkali borates and the like, which are responsible for the undesirable delamination tendency, being efficiently purged from the interior of the glass bottle and glass bottles having a controlled high quality can thus be produced. During the further processing of the base of the glass bottle, a purge gas flow which prevails permanently or in a non-interrupted manner, respectively, at least during those further processing steps for the further processing of the base of the glass bottle in which the bases of the glass bottle, by way of the viscosity thereof, are still deformable and in which alkali borates, sodium, and the like, exit from the still-hot glass so as to precipitate immediately again on cooler regions of the glass bottles is thus configured according to the invention. The purge gas flow thus flows, such as continuously, during the entire further forming of the base of the glass bottle, this explicitly not being intended to exclude a certain variation of the mass flow during individual processing steps which are carried out during the further forming of the base of the glass bottle.

In order to generate a flow which is coaxial in terms of the centerline of the glass bottle, a tube, by way of which the purge gas is supplied, can be disposed on the glass bottle centerline and so as to be symmetrical to the latter. It is only important herein that the purge gas flows into the glass bottle or is suctioned out from the latter, respectively, in an axial and centric manner. Alternatively, the purge gas, by way of a ring nozzle or the like, or by way of a plurality of nozzles or tubes that are disposed so as to be distributed along the circumference of the filling openings, can flow in or out in an eccentric manner, and flow out or in in a centric manner, by way of the filling opening.

By virtue of the usually rotationally symmetrical shape of glass bottles and of the filling openings of the latter, rotationally symmetrical shapes of the tube may be used. In principle, a non-centric disposal of the tube is also conceivable in the use of tubes which generate an asymmetrical flow.

The tube herein can either be operated as a blower tube, that is to say for blowing the flow into the glass bottles, or as a suction tube, that is to say for suctioning the flow out of the glass bottles, and can have various embodiments which are described in more detail herein. It is a common feature of all tube constellations that said tube constellations have a tube external diameter d_{r,a} and at least one tube internal diameter d_{r,i}, and a wall thickness which is consequently defined as (d_{r,a}-d_{r,i})/2 and is sufficient to guide a purge gas at the required pressure, without the flow resistance herein being excessively high for the supply of the purge gas.

According to some exemplary embodiments disclosed herein, a method for producing glass bottles having a flat base and an opposite filling opening is provided. The method comprises the following steps: locally heating one end of a glass tube; configuring a flange or a rolled rim, having the filling opening at the locally heated end of the glass tube; severing the locally heated end of the glass tube while configuring a glass bottle having a closed base; and further forming of the base of the glass bottle. The glass bottle having the closed base that is configured after severing the locally heated end of the glass tube from the glass tube herein is held upside down. During the further forming of the base of the glass bottle at temperatures between 1000° C. and 1200° C. in the region of the closed base, such as in any case at temperatures above 1100° C. in the region of the closed base, with the aid of a purge gas a continuous purge gas flow is generated in the interior of the glass bottle.

According to the invention, it is expressly not to be a matter of the exact circumstances herein as to how the purge gas flow is generated in the interior of the glass bottles, thus of how exactly the purge gas flows into the glass bottles or is optionally suctioned out of the latter. It is only important herein that a sufficiently strong purge gas flow which to a sufficient extent prevents any delamination is provided in the interior of the glass bottle. To this end, it suffices when the purge gas flow that prevails in the interior of the glass bottles to a sufficient extent prevents any precipitation of the vapors, in particular in an annular zone at a certain spacing from the bottle base, thus in particular of alkali borate or sodium, which by virtue of the very high temperatures prevailing in the region of the base exit from the hot glass in the further forming of the base of the glass bottle, to cooler regions of the glass bottles, this being prevented in that the vapors are purged from the interior of the glass bottles.

In some embodiments, the tube by way of which the purge gas is blown into the interior of the glass bottles or is suctioned out of the interior of the glass bottles, is a cylindrical tube, wherein the purge gas is blown into or suctioned out of the interior of the glass bottles by way of a front end of the tube. The cylindrical tube expediently has a consistent wall thickness, in particular close to the front end. The purge gas flow at the front end of the tube can thus be aligned and guided exactly so as to be parallel and coaxial with the glass bottle in a simple manner, this facilitating the configuration of laminar flow conditions in the interior of the glass bottle.

A cylindrical shape of the tube is also advantageous in the case of the purge gas being suctioned out of the interior of the glass bottle, because the purge gas can thus be suctioned out of the filling opening in a symmetrical manner, for instance when the purge gas is to flow into the glass bottle in an eccentric manner and is to be suctioned out of the filling opening in an exactly centric and axially-directed manner. This can be achieved by a disposal of the tube which is exactly parallel with the longitudinal axis of the glass bottle and concentric with the glass bottle.

In some embodiments, the cylindrical tube at the front end thereof furthermore has a conically tapered external profile. A reverse flow that flows out of the glass bottle again can be discharged to the outside in a uniform and symmetrical radial manner on account of the external profile, such that a back pressure which could influence the flow conditions in the interior of the glass bottle in an undesirable manner can be effectively avoided. The tube for a comparable mass flow of the purge gas can therefore also be disposed so as to be closer to the filling opening. This shape of the front end of the tube is particularly suitable in the use of the tube as a blower tube for blowing purge gas into the glass bottle. By virtue of the tapering of the tube at the front end thereof, the tube can readily also plunge into the internal volume of the glass bottle by way of the filling opening, in particularly only to a head region of the glass bottle, and herein nevertheless enable a sufficiently uniform discharge of the purge gas which flows out of the internal volume of the glass bottle again. In comparison to tubes having a consistent external diameter, the risk of any collision with the glass bottle and thus of damage to the glass bottle is also lower by virtue of the external profile.

In some embodiments, the cylindrical tube at the front end thereof furthermore has a conically tapered internal profile. On account of the tapering of the internal profile, a nozzle which enables a flow having a comparatively high pressure and a comparatively small cross-sectional area to be provided, is created herein. This embodiment of the tube is particularly suitable in the use of the tube as a blower tube. Exact guiding of the purge gas flow into the interior of the glass bottles can in particular be achieved on account of the conically tapered shape herein, and a laminar purge gas flow can thus be achieved in a simple manner. The tube herein may taper in a conical manner only close to the open end such that an overall comparatively low flow resistance can be achieved.

In some embodiments, the cylindrical tube at the front end thereof furthermore has a portion having a cylindrical internal profile. This portion, conjointly with the cylindrical internal profile, may directly configure the exit opening of the tube. This portion can furthermore assume the function of a nozzle, as has been explained previously, but herein further align and guide the exiting purge gas flow, specifically so as to be exactly coaxial with the longitudinal axis of the glass bottle, this further facilitating the build-up of laminar flow conditions in the interior of the glass bottle.

In some embodiments, the cylindrical tube at the front end thereof furthermore has a portion having a cylindrical external profile. This portion, conjointly with the cylindrical external profile, may directly configure the exit opening of the tube. Said portion herein, by way of a comparatively small external diameter, can also project from the remainder of the tube, for instance when the tube ahead thereof is configured so as to have a conically tapered external profile. The portion having the cylindrical external profile can thus at least in portions plunge into the internal volume of the glass bottle, in particular only to a head region of the glass bottle. The portion having a conically tapered external profile that adjoins the portion having the cylindrical external profile can herein nevertheless enable a sufficiently uniform discharge of the purge gas which flows out of the internal volume of the glass bottle again. As compared to tubes having a consistent external diameter, the risk of any collision with the glass bottle and thus of any damage to the glass bottle is lower by virtue of the external profile.

In some embodiments, the tube is disposed outside the glass bottle at a predetermined axial spacing from the filling opening. Said predetermined axial spacing can be a further important factor in terms of the purging performance and will be discussed in detail further herein. This spacing enables in particular a uniform discharge in a radially outward manner of the purge gas flow which flows out of the glass bottle again, without any substantial consequential effect on the flow conditions at the front end of the tube. Because the tube in the case of these embodiments is disposed outside the glass bottle, a locationally-fixed position of the tube is enabled such that the tube does not have to be driven into the glass bottle and driven out of the glass bottle again in each cycle of the rotor portion of the base machine.

The predetermined axial spacing of the tube from the filling opening herein may be in a range between 0.1 mm to 5.0 mm, such as in a range between 0.1 mm to 2.0 mm or in a range between 0.1 to 1.0 mm. In other words, the front end of the tube is in principle disposed as close as possible to the filling opening such that no collision with the glass bottle occurs and damage to the glass bottle can thus be precluded. To this end, the aforementioned spacing of the tube from the filling opening of the glass bottle does not have to be miniscule, thus larger than 0.0 mm, but can in principle also be slightly smaller than the aforementioned lower limit value of 0.1 mm. Nevertheless, a sufficiently dimensioned gap ensures a uniform discharge in a radially outward manner of the purge gas flow which flows out of the glass bottle again, without any substantial consequential effect on the flow conditions at the front end of the tube.

In some embodiments, the tube is disposed on a surface, wherein the front end of the tube is disposed at a predetermined spacing from the surface, said predetermined spacing being in a range from 5.0 mm to 15.0 mm. This surface can be the upper side of a chuck to which the tube is fastened and which during the further processing steps for the forming of the base is disposed so as to be locationally fixed in relation to the glass bottle, for example in relation to a chuck or a mounting by way of which the glass bottle is held during the further processing steps for the forming of the base. The purge gas flow exiting from the glass bottle impacts said surface and prior thereto has to be discharged to a sufficient extent in a manner directed radially outward so as to avoid any undesirable influence on the flow conditions in the interior of the glass bottle or else in the environment of the filling opening. This can be set in a simple manner by way of a suitable selection of the spacing of the front end of the tube from said surface.

This embodiment may be advantageous for tubes which at the front end thereof have a conically tapered external profile and when in this instance at least the portion having the conically tapered external profile projects from the surface, because the influence of the external profile on the guiding of the exiting purge gas flow comes into full effect only in this way. Moreover, the thermal conditions in the region of the front end of the tube can be favorably influenced by way of the aforementioned spacing of the front end of the tube from said surface.

In some embodiments, the aforementioned predetermined axial spacing is in a range from 6.0 mm to 12.0 mm or is at least 10.0 mm.

In some embodiments, the tube herein is disposed outside the glass bottle at a predetermined axial spacing from the filling opening. Complex experiments have shown that the purging effect herein decreases substantially exponentially as the spacing of the tube from the filling opening of the glass bottle increases, or as the mass flow M of the purge gas decreases. However, a disposal of the tube outside the glass bottle may be preferred for the aforementioned reasons, because no complex axial adjustment of the tube is required, such that comparatively minor spacings as explained above may be preferred in the case of such embodiments.

Moreover, the purging effect decreases significantly as the tube internal diameter d_{r,i} increases, since a lower flow velocity in relation to the cross-sectional area is present here. Experiments have shown herein that the purging effect is not a function of the tube external diameter d_{r,a} as long as the latter is not larger than approximately ⅔ of the filling opening internal diameter d_{g,i}. The tube herein is normally disposed at a predetermined spacing in a range between 0.1 mm to 5.0 mm. However, a disposal at an axial spacing from the filling opening of the glass bottle in a range between 0.1 mm to 2.0 mm, such as in a range between 0.1 mm to 1.0 mm. The embodiments mentioned may be particularly advantageous because the tube does not have to be plunged into the glass bottle (and be retracted therefrom again) so that an axial adjustment of the tube is not required, which aids in reducing the complexity in terms of instrumentation for carrying out the further processing steps.

In some embodiments, the tube by way of the filling opening can also plunge axially into the glass bottle by a predetermined distance (A). An improved purging effect can result on account of said slight plunging. However, in this instance, an additional plunging device, or a device for the axial adjustment of the tube, respectively, has to be provided, said device suitably adjusting the tube in an axial manner for the further processing steps, in particular plunging said tube sufficiently far into the filling opening or the glass bottle, respectively, at a suitable temporal point, and moving said tube back again at another suitable temporal point. On account thereof, the production process can indeed be made more difficult, and the complexity in terms of instrumentation for carrying out the further processing steps can indeed be increased, this however being potentially more than compensated for by a more favorable predefinition of the flow conditions in the main volume of the glass bottle. In the case of these embodiments, the tube in the further forming of the base of the glass bottle can be axially adjusted in a manner corresponding to a movement path of the glass bottle such that the tube for generating the purge gas flow, at a respective processing station of the base machine, plunges axially into the glass bottle by the predetermined distance, and for the onward transportation of the glass bottle to a processing station of the base machine that is situated downstream is axially retracted to a position outside the glass bottle, so as to clear the movement path of the glass bottle. Thus the tube per cycle of the rotor proportion of the base machine is in each case expediently introduced in the glass bottle, so as to carry out a respective processing procedure, and is withdrawn again after said processing procedure has been carried out. The plunged position of the tube is thus not prevalent over the entire cycle time of the respective processing procedure.

The tube herein can in particular also be disposed in the main volume of the glass bottle, thus plunge beyond a constricted neck region of the glass bottles and into the main volume of the glass bottle. The tube herein is expediently disposed in such a manner that said tube has a sufficient spacing from the base of the glass bottle. The predetermined spacing is typically to be set in a suitable manner in order to avoid any undesirable excessive cooling on the base of the glass bottle.

In some embodiments, the flow rate of the purge gas herein is chosen such that any undesirable intense cooling in the region of the base of the glass bottle is avoided. To this end, the flow rate of the purge gas can also be varied during the further processing steps for the forming of the base, for example as a function of the respective processing step, as is explained in more detail herein.

In some embodiments, the glass bottles are so-called narrow-neck glass bottles which have a neck internal diameter in the range from 6.0 mm to 13.0 mm, and a neck length of at most 12.0 mm. The geometry for generating the purge gas flow disclosed in the present application is advantageous in particular in the case of such narrow-neck glass bottles because a suitable purge gas flow for purging vapors can nevertheless be generated in the interior of the glass bottles despite the very tight internal width of the glass bottles in the region of the filling opening. The high cycle frequencies between the individual processing steps in the further forming of the bases of the glass bottles are to be considered herein, said high cycle frequencies requiring that complex axial adjustments of tubes and/or ring nozzles for the generation of the purge gas flow are to be avoided if possible.

Extremely hot glass is present in particular on the base of the glass bottle in the processing steps which serve for the further forming of the glass bottle base, such that alkali borates and further substances increasingly evaporate on the base. According to the invention, a defined laminar and coaxial purge gas flow in the interior of the glass bottle is generated in such a manner on account of the aforementioned blowing-in of the purge gas, that the alkali borates and the like on the base of the glass bottle are first acquired by said purge gas flow and are then immediately and continuously purged out of the glass bottle by way of the filling opening of the glass bottle. The purge gas flow herein may be switched on already immediately prior to the actual severing step for severing the locally heated end of the glass tube from a glass tube, thus already prior to the onset of an intense alkali borate evaporation caused by the processing temperature, and said purge gas flow is maintained at least during the entire further shaping process of the base, such that a stable purge gas flow can already be built up in an early stage of the forming of the bases of the glass bottles, in particular already during the configuration of a closed base when severing the locally heated end of the glass tube, and no gaseous alkali borates or the like can accumulate in the interior of the glass bottle and precipitate again in cooler regions during the further processing steps for the further forming of the bases. Under certain circumstances, the purge gas flow is additionally also maintained in further method steps. This is the case in particular in the production of comparatively large glass bottles, thus glass bottles having a greater length, in which comparatively high temperatures of the glass continue to prevail over a comparatively long time even after the base forming process, this potentially necessitating a purge gas flow even during the following cooling steps.

In some embodiments, the correlation (d_{g,i})²−(d_{r,a})²≥(d_{r,i})² applies to the filling opening internal diameter d_{g,i}, to the tube external diameter d_{r,a} and to the tube internal diameter d_{r,i}. It is guaranteed on account thereof that the cross-sectional area of the outflowing proportion of the purge gas is at least the same size as that of the inflowing proportion of the purge gas such that sufficient purge gas can be directed into the glass bottles, and the counter-directed purge gas flows do not influence one another. The wall thickness of the tube herein can be chosen according to the requirement, wherein the tube external diameter d_{r,a} however should always be smaller than the filling opening internal diameter d_{g,i}, so as to enable a sufficient outflow of the contaminated purge gas. Tubes having wall thicknesses in the range 1.0 mm to 3.0 mm may be used. The tube internal diameter d_{r,i} is limited downward in order to keep the flow resistance sufficiently low, so that sufficiently high mass flows can be provided in the interior of the glass bottle already at a low pressure, and the leakage flows on account of the low-pressure can simultaneously be kept low in the only gap-sealed filling opening and toward the top are only delimited by the tube external diameter minus the wall thickness.

In some embodiments, the further forming of the bases of the glass bottles comprises a plurality of processing steps, wherein the mass flow of the purge gas flow in at least one of the plurality of processing steps is different from the other processing steps. On account thereof, the required purging effect can be controlled in a suitable manner in relation to the alkali borate quantity arising, while taking into consideration the unintentional cooling effect that has been created. The mass flow of the purge gas flow entering the glass bottles herein can expediently be in a range between 2.4 standard liters/min and 20 standard liters/min according to DIN 1343 or ISO 2533.

In some embodiments, a purge gas is suctioned through the tube from the interior of the glass bottle wherein the tube is disposed within the main volume of the glass bottle at the aforementioned predetermined axial spacing from the filling opening of the glass bottle. The tube herein can also plunge comparatively deep into the glass bottle. A vacuum system, in particular in the form of a pump, generates a suitable negative pressure in order for the purge gas which flows into the glass bottle in an eccentric manner, to be suctioned out of the latter in a centric manner. Said vacuum system can be provided with a filter installation which filters the suctioned purge gas so as to prevent damage to the vacuum system. The purge gas herein can be blown into the interior of the glass bottles at a suitable mass flow, as has been explained previously, in an eccentric manner by way of a ring nozzle or a plurality of nozzles or tubes which are disposed so as to be distributed along the internal circumference of the filling openings of the glass bottles.

In some embodiments, the tube internal diameter is at least 1.5 mm. A sufficient suction force can be guaranteed on account thereof, wherein no back pressure is created in the tube, but a sufficient purge gas flow that prevails in a substantially permanent manner is configured in order for the alkali borate gases to be efficiently suctioned.

In some embodiments, the correlation d_{r,a}<d_{g,i}−2.0 mm applies to the correlation of the tube external diameter d_{r,i} and the filling opening internal diameter d_{g,i}. It is guaranteed on account thereof that sufficient purge gas can flow into the glass bottle such that no undesirable negative pressure which suctions the base of the glass bottle and negatively compromises the shaping of said glass bottle or even allows said glass bottle to collapse is created.

In some embodiments, for compensating an additional cooling effect by virtue of the purge gas flow, in the further forming of the bases of the glass bottles an additional heating output that acts eccentrically is provided at least in portions, in particular by way of an eccentric disposal of a plurality of gas burners which in each case act on the bases of the glass bottles. The heating output herein can be suitably adapted to the mass flow of the purge gas flow, in order for the additional cooling effect by virtue of the purge gas flow to be compensated.

In some embodiments, at least one additional gas burner which can in particular be present as a knot burner, generates an additional heating output which may be provided in a centric manner and which acts on the base of the glass bottle. It can be guaranteed on account of this additional heating output that a desired plasticity of the glass bottle base is maintained during the entire further processing process. The heating output herein counteracts any potential undesirable cooling effect of the purge gas.

In some embodiments, a method for producing glass bottles is provided in which an additional heating output that acts centrically on the bases of the glass bottles is provided in the further forming of the bases of the glass bottles, in particular by way of a gas burner which may act in an exactly centric and perpendicular manner on the bases of the glass bottles so as to sufficiently soften a knot from plastic glass which is optionally configured in the shaping of the base such that said knot can be minimized and homogenized by rotating the glass bottle and optionally by further measures (said gas burner hereunder also being referred to as a knot burner).

The additional cooling effect by virtue of the purge gas flow that flows into the interior of the glass bottles in the further forming of the bases of the glass bottles can in particular be compensated according to the invention by way of such a burner. When the purge gas flow flows into the glass bottles in a centric manner, the cooling effect arises substantially in the center of the base being configured. By contrast, when the purge gas flow flows into the glass bottles in an eccentric manner, the aforementioned cooling effect arises substantially in an annular region close to the center of the base being configured. In both cases, the additional cooling effect can be sufficiently compensated when the heating output is sufficiently widened, thus does not act in a punctiform manner but in a specific planar region, on the base being configured, this being able to be achieved in an advantageously simple manner by a gas burner, in particular a so-called knot burner. A mechanical action on the base being configured is also achieved in particular by a gas flame. For example, when the purge gas flow is chosen to be too excessive so that the base to some extent would be bulged by said purge gas flow, said bulging can also be counteracted by the mechanical effect of the gas flame. Of course, this additional heating output can also vary in temporal terms, in particular be chosen so as to be different during different processing steps in the further forming of the bases of the glass bottles.

In some embodiments, the aforementioned gas burner is disposed and conceived for generating a gas flame which acts perpendicularly or substantially perpendicularly on the bases of the glass bottles.

The aforementioned method is particularly suitable for producing glass bottles (vials) from borosilicate glasses, such as are used for storing substances for pharmaceutical or medical purposes.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 shows a schematic illustration of the processing positions of the production method of an exemplary embodiment provided according to the present invention;

FIG. 2 shows a schematic illustration of a glass bottle which has been produced by a production method provided according to an exemplary embodiment of the present invention;

FIG. 3A shows a schematic illustration of an exemplary embodiment of a cylindrical tube of the production method of the present invention;

FIG. 3B shows a schematic illustration of another exemplary embodiment of a cylindrical tube of the production method of the present invention;

FIG. 3C shows a schematic illustration of another exemplary embodiment of a cylindrical tube of the production method of the present invention;

FIG. 3D shows a schematic illustration of another exemplary embodiment of a cylindrical tube of the production method of the present invention;

FIG. 4A shows a schematic illustration of placing a tube in front of the filling opening of a glass bottle during the production method of an exemplary embodiment of the present invention;

FIG. 4B shows a schematic illustration of placing a cylindrical tube in the head region of a glass bottle during the production method of an exemplary embodiment of the present invention;

FIG. 4C shows a schematic illustration of placing a cylindrical tube in the main volume of a glass bottle during the production method of an exemplary embodiment of the present invention;

FIG. 5A shows a schematic illustration of a phase of the blowing-out process of the production method in an exemplary embodiment of the present invention;

FIG. 5B shows a schematic illustration of another phase of the blowing-out process of the production method in an exemplary embodiment of the present invention;

FIG. 5C shows a schematic illustration of yet another phase of the blowing-out process of the production method in an exemplary embodiment of the present invention;

FIG. 5D shows a schematic illustration of yet another phase of the blowing-out process of the production method in an exemplary embodiment of the present invention; and

FIG. 6 shows a schematic illustration of an additional gas burner of the production method in an exemplary embodiment of the present invention.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

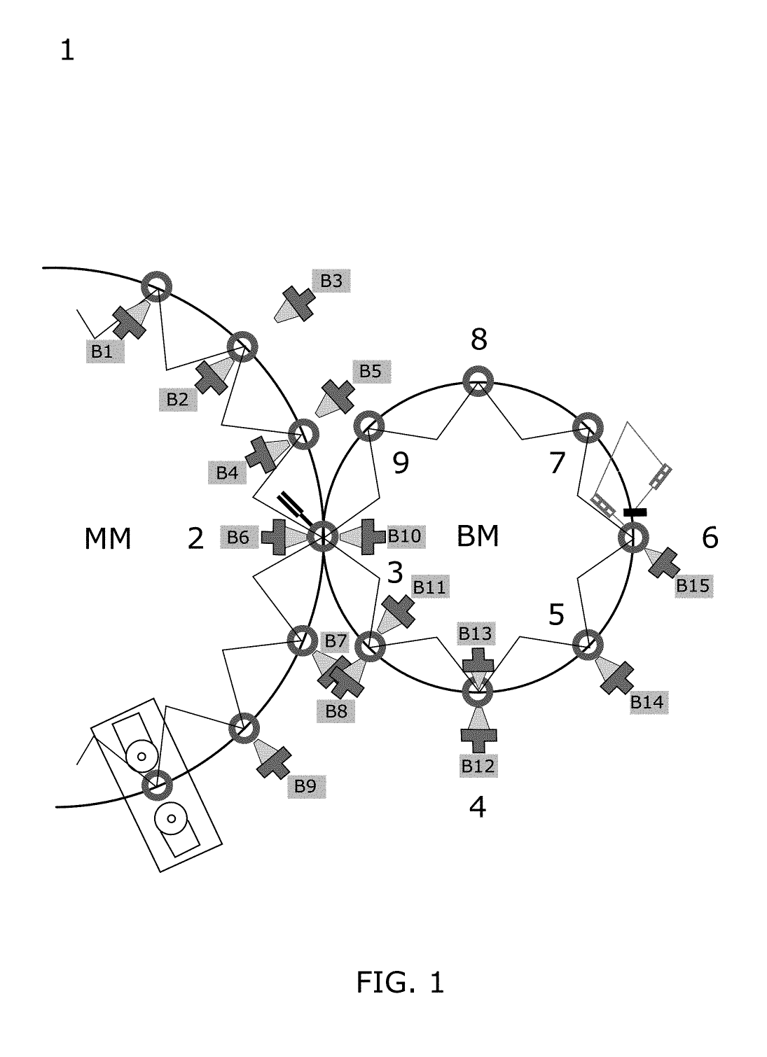

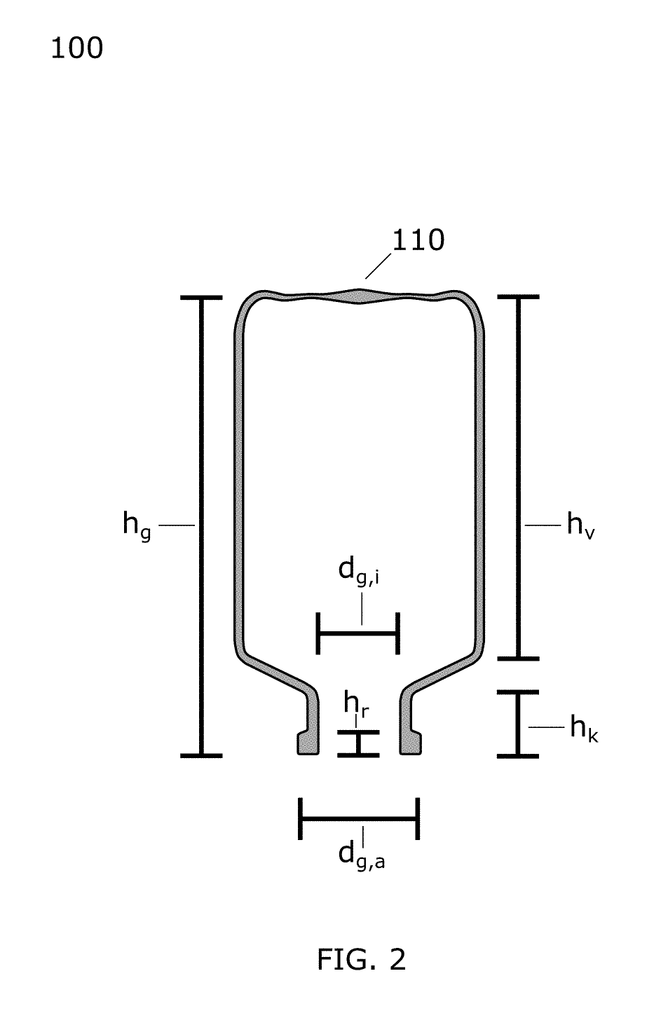

An exemplary embodiment of a device 1 provided for producing glass bottles according to the present invention is schematically illustrated in FIG. 1. Illustrated are a so-called mother machine MM and a downstream so-called base machine BM having various processing positions, wherein a multiplicity of burners B1-B15 are disposed at specific processing positions. Both the base machine BM, as well as the mother machine MM, are composed of a rotor proportion and a stator proportion, wherein the rotor proportions rotate once about their own axis during one production cycle. In the transfer from the mother machine MM to the downstream base machine BM, a flange or a rolled rim, having the filling opening at the locally heated end of the glass tube, is configured by locally heating one end of a glass tube. Furthermore, the severing of the locally heated end of the glass tube is performed while configuring a closed base. The processing positions of the base machine BM that are mutually spaced apart in spatial terms serve for the further forming of the bases of the glass bottles 100 that are severed from the glass tube (cf. FIG. 2) and comprise at least one severing step 2 at which the actual severing of a locally heated end of the glass tube is performed while configuring the closed base, a first base forming step 3, a second base forming step 4, a third base forming step 5, a die base forming step 6, a base cooling step 7, a retrieval step 8, and an idle step 9. The glass bottles 100 are held upside down in all of aforementioned processing steps. The glass bottles 100 in the base machine BM by the rotor proportion are moved in a cycled manner along a predetermined movement path from a processing position that is situated upstream to a processing position that is situated downstream. In some embodiments, no height adjustment of the glass bottles 100 is performed herein, so that the rolled rim, or the flange, respectively, of the glass bottles 100 is at all times at the same height level in the base machine BM.

In detail, the following processing procedures are carried out successively in a cycled manner in the previously described steps:
In the severing step 2, one end of a glass tube is locally heated, such as by gas burners, and a flange or a rolled rim, having the filling opening at the locally heated end of the glass tube, is configured by locally heating the end of a glass tube. Furthermore, the severing of the locally heated end of the glass tube while configuring a closed base is performed. The glass bottles 100 being created, the neck of said glass bottles 100 already having been formed and the base of said glass bottles 100 being heated, are first received upside down by a holding device of the base machine BM;
in the first base forming step 3, the bases of the glass bottles 100 are processed by way of at least one burner so as to roughly form the bases of the glass bottles;
in the second base forming step 4, the bases of the glass bottles 100 are further processed by way of at least one burner so as to form the bases of the glass bottles 100 to be flat;
in the third base forming step 5, the bases of the glass bottles 100 are further processed by way of at least one burner so as to further refine the already formed bases of the glass bottles 100;
in the die base forming step 6, the bases of the glass bottles 100, while applying a relatively high gas pressure (such as 0.5 to 3.0 bar) are pressed into a mold so as to finally form the bases;
in the base cooling step 7, the bases of the glass bottles 100 are cooled;
in the retrieving step 8, the finished glass bottles 100 are retrieved from the base machine BM; and
in the idle step 9 the holding unit of the base machine is empty so as to again receive a new glass bottle 100 in the next step.

In the production method 1 described previously, the bases of the glass bottles 100 are relatively plastic, in particular in steps 2 to 5 (but also in step 6), that is to say that said bases have a relatively low viscosity. The further forming of the bases of the glass bottles is expediently performed at temperatures between 1000° C. and 1200° C. in the region of the closed base, such as in any case at temperatures above 1100° C. in the region of the closed base. In order for the bases not to fall (that is to say collapse) into the glass bottles, a static back pressure is generated in the interior of the glass bottles in the case of some known methods. By contrast, according to the present invention a purge gas flow which acts permanently at least during the further processing steps for the forming of the base 2 to 5 (but also 6) and which flows through the interior of the glass bottles, as is explained further herein, so as to additionally clean the glass bottles of arising alkali borates in a controlled manner and to counteract any delamination.

A glass bottle 100 as a product of the production method provided according to the present invention is schematically illustrated in FIG. 2. The glass bottle has a flat base, a cylindrical, smooth side wall, a tapered shoulder portion, a constricted neck portion adjoining said shoulder portion, and an upper end having a filling opening and a flange having a rolled rim or a molded external thread. The glass bottle herein has an overall height h_{g}, wherein the glass bottle main segment has a height hᵥ, and wherein the glass bottle head segment has a height hₖ, and wherein the glass bottle rolled rim has a height hᵣ. The glass bottle 100 furthermore has a filling opening external diameter d_{g,a} and a filling opening internal diameter d_{g,i}. A knot-shaped region made from glass is illustrated in the central region of the glass bottle base in FIG. 2, said knot-shaped region potentially being created during the severing step 2 and being minimized and homogenized in the subsequent base forming steps 3 to 5, so as to configure an ideally flat base.

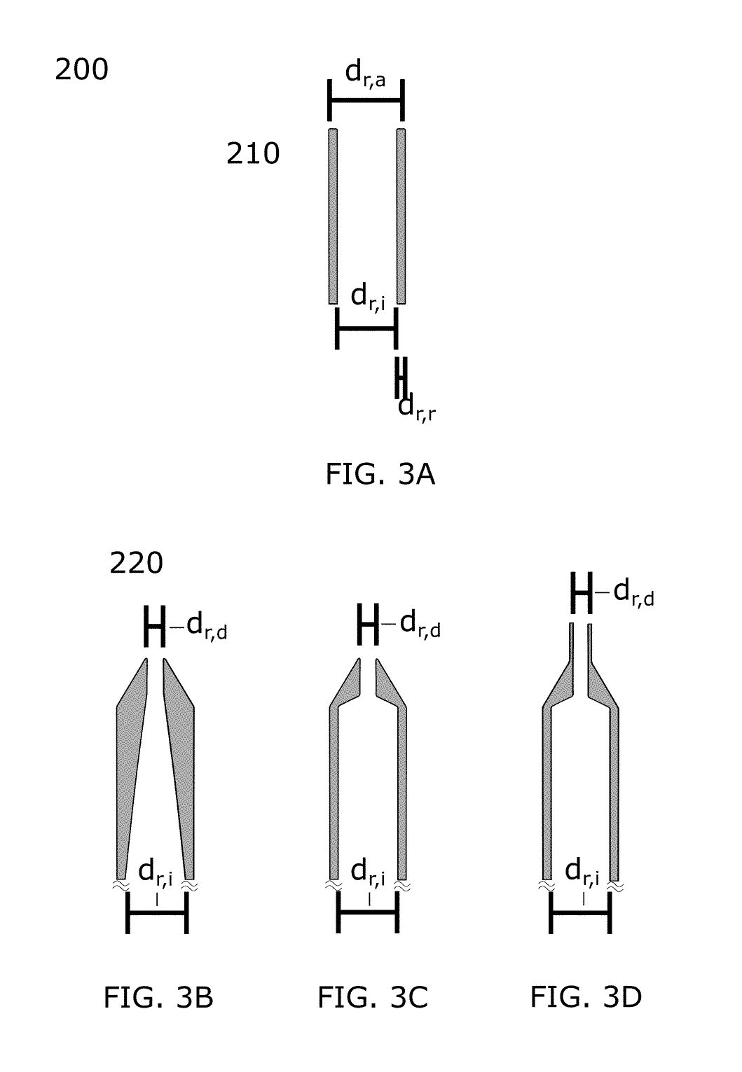

An exemplary embodiment of the tube 200 for blowing in or suctioning out the purge gas is illustrated in FIG. 3A, said purge gas being used in the production method, wherein the tube 200 according to this embodiment is configured as a cylindrical tube 210 having a front open end. The cylindrical tube 210 herein furthermore has a consistent tube external diameter d_{r,a}, a consistent tube internal diameter d_{r,i}, and a consistent tube wall thickness d_{r,a}. The cylindrical tube 210 can in particular be disposed in relation to a holding unit of the base machine BM, so as to blow a purge gas into a glass bottle 100 or suction said purge gas out of the latter. Depending on the stress in terms of pressure or heat, the tube wall thickness d_{r,a} of the cylindrical tube 210 that is open at the top can vary.

Another exemplary embodiment of the tube which may be used in one further embodiment of the production method is illustrated in FIG. 3B, wherein the tube 220 according to this embodiment is configured as a tube having a conically converging and tapering end. More specifically, the tube 220 has a tapered tube internal diameter d_{r,i}, wherein the tube external diameter d_{r,a} is substantially consistent across the entire length of the tube but close to the front end converges in a conical manner. The length across which the tube internal diameter d_{r,i} decreases is significantly greater than the length across which the tube external diameter d_{r,a} decreases. Using such a tube 220, purge gas flows having a comparatively high pressure can in particular be generated, since the conically converging and tapering end of the tube 220 is configured overall as a nozzle. Moreover, the purge gas proportion flowing out of the interior of the glass bottle can efficiently flow away on the external surface of the tube 220. Because of the tube internal diameter d_{r,i} being comparatively large across the major part of the tube 220, a comparatively low flow resistance can thus be overall achieved in the tube 220, this enabling significant advantages in terms of the mechanical implementation, in particular not requiring any complex sealing measures.

Another exemplary embodiment of the tube in which the length across which the tube external diameter d_{r,i} decreases is equal to the length in the embodiment according to FIG. 3B, but the length across which the tube internal diameter d_{r,i} decreases is significantly smaller is shown in FIG. 3C. The purge gas flow in the case of this embodiment is indeed formed in a less gentle manner to a purge gas flow having a smaller diameter. This can however be sufficient. The same advantages as have been described above in the context of the embodiment according to FIG. 3B are maintained herein.

A cylindrical portion as is shown in FIGS. 3B and 3C can be configured at the exit opening of the tube 220 in the case of the embodiments according to FIGS. 3B and 3C.

Another exemplary embodiment of the tube in which this cylindrical portion at the front end is lengthened in the axial direction by a sleeve having an internal diameter d_{r,a} so as to suitably form the exiting purge gas flow is shown in FIG. 3D. The same advantages as have been described above in the context of the embodiment according to FIG. 3B are also maintained in the case of this embodiment.

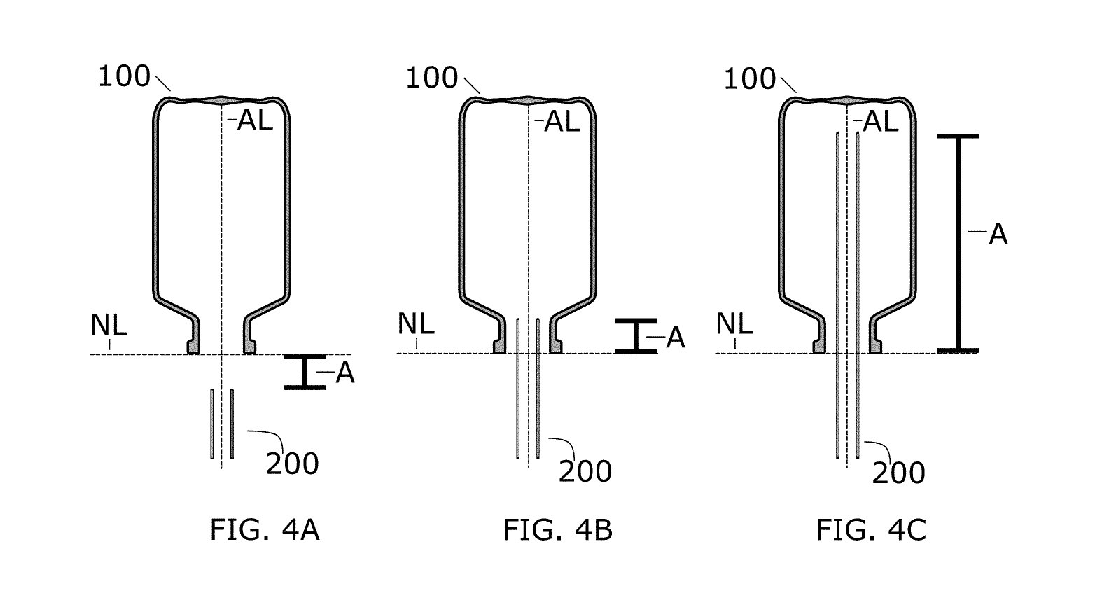

A placement of the tube 200 in the production method is illustrated in FIG. 4A, in which the tube 200 is disposed at a predetermined spacing A from the filling opening and outside the glass bottle 100. In this embodiment, the tube 200 during the production process 1 does not penetrate the glass bottle 100 and can therefore be disposed so as to be immovable in relation to a holding unit of the base machine BM. In order for an optimum purge gas flow to be provided in the glass bottle, the tube 200 must not be too far from the filling opening, since an insufficient mass flow M of the purge gas flow 50 would be provided in this case. The predetermined axial spacing A from the filling opening can in particular be in a range between 0.1 mm to 5.0 mm, more preferably in a range between 0.1 mm to 2.0 mm, even more preferably however in a range between 0.1 mm to 1.0 mm. The predetermined axial spacing A from the filling opening is in any case larger than 0.0 mm, thus not minuscule. The tube 200 can in particular be configured such as has been described in an exemplary manner above by FIGS. 3A to 3D.

Because the tube 200 in the further forming of the base of the glass bottle 100 is disposed outside the glass bottle 100, no adjustment installation for the axial adjustment of the tube 200 is required in principle. A locationally-fixed position of the tube 200 outside the glass bottle 100 is thus enabled. The tube 200 does not have to be moved into the glass tube 100 and be moved out of the latter again in each cycle of the rotor proportion of the base machine BM, this potentially significantly simplifying the further forming of the base of the glass bottle 100.

In some embodiments, the tube 200 is disposed on or fastened to, respectively, a surface, for example a chuck having a planar surface, wherein the front end of the tube 200 is disposed at a predetermined spacing from the surface, said spacing being in a range from 5.0 mm to 15.0 mm. Said surface during the further processing steps for the forming of the base is disposed so as to be locationally fixed relative to the glass bottle 100, for example relative to a chuck or a mounting, by way of which the glass bottle is held during the further processing steps for the forming of the base. The chuck, or the mounting, respectively, in the base machine BM thus rotates in a manner synchronous to the respectively assigned glass bottle along the movement path on the processing stations of the base machine BM. The purge gas flow exiting the glass bottle impacts said surface and prior thereto has to be sufficiently discharged in a manner directed radially outward so as to avoid any undesirable influence on the flow conditions in the interior of the glass bottle or else in the environment of the filling opening. This can be set in a simple manner by way of a suitable choice of the spacing of the front end of the tube from said surface.

This embodiment may be particularly advantageous for tubes which at the front end thereof have a conically tapered external profile, when in this instance at least the portion having the conically tapered external profile projects from the surface, in particular by a length in a range from 5.0 mm to 15.0 mm, such as in a range from 6.0 mm to 12.0 mm or at most 10.0 mm.

Another exemplary placing of the tube 200 in the production method in which the tube 200 for generating the purge gas flow is disposed in the head region of the glass bottle is illustrated in FIG. 4B. An advantageous purging effect can be achieved in the interior of the glass bottle 100 on account of this embodiment. However, the tube 200 has to be introduced to a certain extent into the glass bottle 100, this necessitating an additional plunging device which axially adjusts the tube 200 and plunges the latter into the glass bottle. To this end, the tube 200 per cycle of the rotor proportion of the base machine BM is in each case expediently introduced first by an axial adjustment into the glass bottle 100, so as to generate the aforementioned purge gas flow in the interior of the glass bottle, and after carrying out the respective processing procedure at the processing station is withdrawn again by an axial adjustment. The plunged position of the tube 200 at the respective processing station of the base machine BM is thus not prevalent over the entire cycle time.

Another exemplary placing of the tube 200 in the production method in which the tube 200 is plunged into the main volume of the glass bottle 100 is illustrated in FIG. 4C. In the case of this embodiment, the front end of the tube 200 (or of the nozzle, respectively) should have a sufficient spacing from the base of the glass bottle 100, in order for the base not to be excessively cooled by the purge gas or indeed for the purge gas not to contact said base. The plunging device described above is also required according to this embodiment, so as to axially adjust the tube 200 and to plunge the latter into the glass bottle. To this end, the tube 200 per cycle of the rotor proportion of the base machine BM is in each case expediently introduced first by an axial adjustment into the glass bottle 100, so as to generate the aforementioned purge gas flow in the interior of the glass bottle, and after carrying out the respective processing procedure at the processing station is withdrawn again by an axial adjustment. The plunged position of the tube 200 at the respective processing station of the base machine BM is thus not prevalent over the entire cycle time.

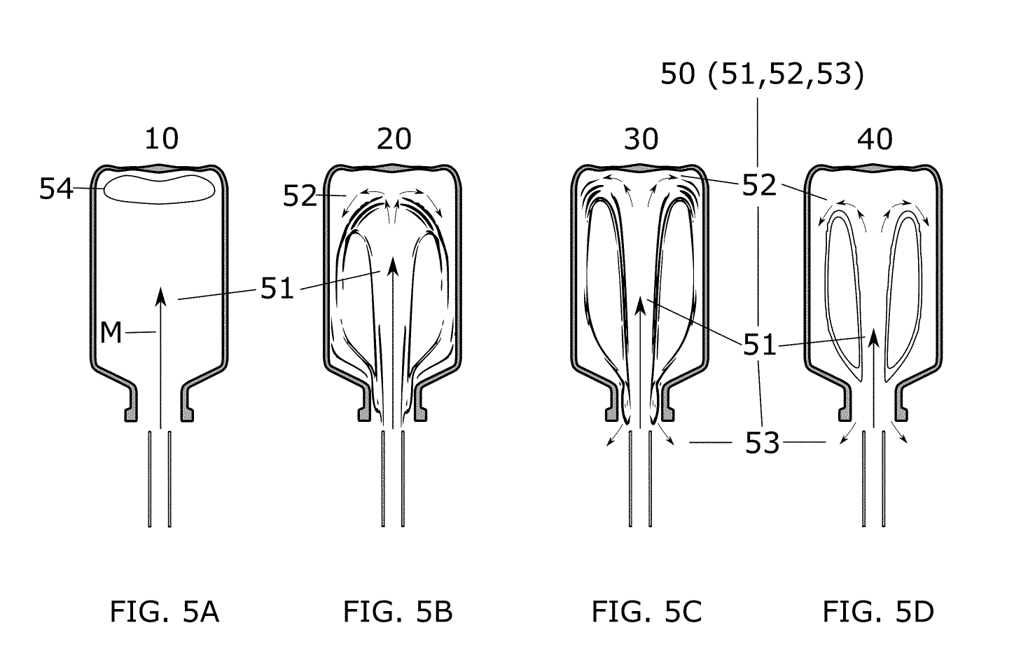

Four phases of a purging procedure of an exemplary embodiment of the production method provided according to the present invention are illustrated in FIGS. 5A to 5D. The individual phases during the further forming of the bases of the glass bottles are described hereunder:
first phase 10 (cf. FIG. 5A): start of the purging process, wherein a purge gas flow 50 in the interior of the glass container 100 is first built up in this phase, and wherein the purge gas flowing out of the tube 200 herein is blown at an appropriate pressure into the interior of the glass bottle 100 such that said entering purge gas flow proportion 51 first presses against the hot gas 54 on the base zone of the glass container 100. The start of the purging process may be performed already when severing the locally heated end from the glass tube, thus at the position 2 in FIG. 1, or else shortly prior thereto.
second phase 20 (cf. FIG. 5B): configuring a cleaning purge gas flow proportion 52, wherein said cleaning purge gas flow proportion 52 is configured in a semi-circular manner between the hot gas 54 at the base zone of the glass container 100 and the entering purge gas flow proportion 51 in the proximity of the glass bottle base. This phase commences immediately after the first phase 10, this being a function in particular of the pressure of the inflowing purge gas and the geometric conditions in the environment of the front end of the tube and the filling opening. The onset of this phase can in particular take place in the transition between the processing steps 2 and 3 in FIG. 1.
third phase 30 (cf. FIG. 5C): configuring an exiting purge gas flow proportion 53, wherein said exiting purge gas proportion 53 if at all interacts to a minimum extent with the entering purge gas proportion 51 and the cleaning purge gas flow proportion 52 and in particular does not configure any turbulences so that the contaminated, hot purge gas 54 is blown out or suctioned out of the glass bottle 100. This phase can in particular begin with the processing step 3 in FIG. 1 and be maintained during the entire processing steps 3 to 6, wherein the mass flow of the purge gas can also be varied between the individual processing steps 3 to 6.
fourth phase 40 (cf. FIG. 5D): terminating the purging process, wherein the pressure of the inflowing purge gas 50 is reduced and the last impurities are purged out of the glass bottle 100.

The onset of the purging procedure can be set in motion either at the beginning of the severing step 2 (cf. FIG. 1) or shortly prior thereto. The purging process may be maintained continuously during the various base forming steps 3 to 5, wherein the respective pressure of the purge gas 50 in the individual steps can readily also be adapted and varied in temporal terms so as to overall achieve an optimum purging effect. In the case of small to medium glass bottle volumes, the purging process is terminated at the beginning of the die base forming step 6. However, in the case of some glass bottles having comparatively large volumes, the glass bottle base, even after the die base forming step 6, is still so hot that alkali borates continue to evaporate on the base, such that maintaining the purge gas flow 50 in this case is also necessary during the base cooling step 7. The cooling effect of the purge gas 50 in this scenario can indeed be desirable.

Further Considerations Pertaining to the Mass Flow of the Purge Gas

The supplied mass flow of the purge gas serves for uniformly coating the internal shell face of the glass bottle. Said mass flow therefore has to be theoretically proportional to the circumference, thus proportional to the tube diameter. Moreover, said mass flow must flow sufficiently rapidly along the wall of the glass bottle and have a sufficient layer thickness in order for all evaporating alkali borates and further proportions to be able to be received and discharged.

The mass flows used are functions of the procedures at the individual processing stations, since the required supporting effect always has to be achieved during the forming of the base but the cooling effect should not exceed a certain degree. Table 1 shows possible values to this end, wherein the mass flows are stated in standard liters/min (sl/min) according to ISO 2533.

TABLE 1
relating to preferred mass flows

| | | | | | | | | | Minimum | | |
|---|---|---|---|---|---|---|---|---|---|---|---|
| | | | Spacing of | | | | | | rotating | Cycle | |
| | Diameter of | Internal | blower tube from | | | | | | speed of | rate of | Length of |
| Diameter | filling opening | diameter of | filling opening | | | | | | chuck of | base | blower |
| of glass tube | of phial | blower tube | of phial | MFC 2 | MFC 3 | MFC 4 | MFC 5 | MFC 6 | phial | machine | tube |
| [mm] | [mm] | [mm] | [mm] | [sl/min] | [sl/min] | [sl/min] | [sl/min] | [sl/min] | [rpm] | [l/min] | [mm] |
| 14.0 | 7.0-8.0 | 2.0/3.0 | 0.5-2.0 | 2.4 | 5.0 | 5.0 | 3.4 | 4.2 | 230 | 40 ± 4 | 19 |
| 16.3 | | | | | | | | | | | |
| 19.3 | | | | | | | | | | | |
| 23.3 | | | | | | | | | | | |
| 29.3 | | | | | | | | | | | |
| 19.3 | 11.8-13.4 | 2.0/3.0 | 0.5-2.0 | 5.0 | 6.0 | 6.0 | 6.0 | 12.0 | 230 | 32 ± 3 | 15 |
| 23.3 | | | | 5.0 | 6.0 | 6.0 | 6.0 | 12.0 | 230 | 33 ± 3 | 15 |
| 29.3 | | 3.0/4.0 | | 6.0 | 6.0 | 6.0 | 8.0 | 12.0 | 230 | 28 ± 3 | 15 |
| 36.3 | | | | 6.0 | 6.0 | 9.0 | 12.0 | 16.0 | 130 | 16 ± 2 | 16 |
| 44.3 | | | | | | | | | | | |

The MFC numbers in Table 1 relate to the processing positions 2 to 5 in FIG. 1. MFC 6 relates to the processing position 6 in FIG. 1 (die base forming step). The assembly spacing of the tube relates to the spacing of the front end of the blower tube above a planar surface, in this case above a chuck base on which the blower tube is assembled so as to be locationally fixed relative to the assigned glass bottle in the base machine. A sufficiently large assembly spacing guarantees a piece of clear axial path for the return flow of the purge gas, until said return flow can be directed in a radially outward manner. This assembly spacing should in principle be chosen to be as small as possible, and may be in a range from 5.0 mm to 15.0 mm, such as in a range from 6.0 mm to 12.0 mm or at most 10.0 mm.

It can be derived from Table 1 that the mass flows used (and the other parameters) primarily depend on the diameter of the bottle and the diameter of the mouth opening. Exemplary ratios and absolute values of the mass flows pertaining to the respective phases of the further base processing can also be derived from Table 1.

The mass flow of the purge gas flow entering the glass bottles according to the invention is expediently in a range between 2.4 standard liters/min and 20 standard liters/min according to ISO 2533, wherein in some embodiments a maximum value of 20 sl/min is not exceeded.

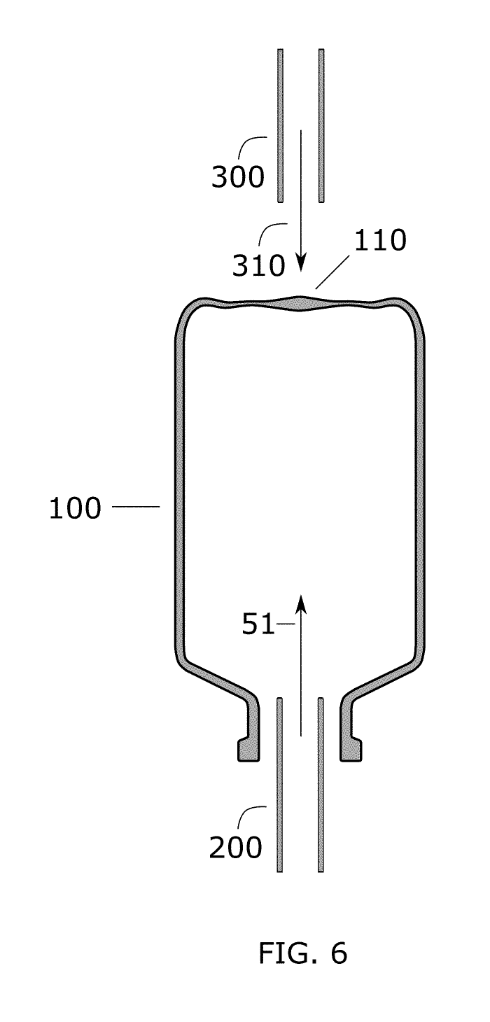

Another exemplary embodiment of the production method in which an additional heating output in the form of a gas flame 310 is provided in the further forming of the bases of the glass bottles on the external side of the glass bottle base by at least one additional gas burner 300 is illustrated in FIG. 6. The gas flame 310 herein can in particular act perpendicularly on the glass bottle base, so as to keep the glass bottle base sufficiently hot and plastic, and on account thereof to in particular counteract the cooling effect of the purge gas 50 in the interior of the glass bottle.

The additional gas burner 300 may be disposed centrically above the base 110 of the glass bottle 100 and directs the gas flame 310 in a centric and coaxial manner onto the base 110 such that a thickened base region (also referred to as a so-called knot) that is optionally configured there is sufficiently heated, such that said thickened base region by way of further measures, in particular a rapid rotation of the glass bottle, can be reduced and, on account thereof, the base of the glass bottle can be configured so as to be planar and having a uniform thickness while adhering to very tight tolerances.

According to some embodiments, for compensating an additional cooling effect by virtue of the purge gas flow, in the further forming of the bases of the glass bottles an additional heating output that acts eccentrically is provided at least in portions, in particular by way of an eccentric disposal of a plurality of gas burners which at a respective processing station are disposed so as to be distributed about the external circumference of the glass bottles, such as at uniform mutual angular spacings, and which in each case act on the bases of the glass bottles.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

### LIST OF REFERENCE SIGNS

1 Device for producing glass bottles
2 Severing step
3 First base-forming step
4 Second base-forming step
5 Third base-forming step
6 Die base-forming step
7 Base-cooling step
8 Retrieving step
9 Idle step
10 First phase (start of the purging process)
20 Second phase (cleaning of the glass bottle base segment)
30 Third phase (cleaning of the glass bottle head segment)
40 Fourth phase (end of the purging process and outflow of the last impurities)
50 Purge gas flow (or purge gas, respectively)
51 Entering purge gas flow proportion
52 Purging purge gas flow proportion
53 Exiting purge gas flow proportion
54 Hot gas (having impurities)
100 Glass bottle
110 Bulge of the glass bottle base
d_{g,a} Opening external diameter of the glass bottle
d_{g,i} Filling opening internal diameter of the glass bottle
h_{g} Overall height of the glass bottle
hᵥ Height of the glass bottle main segment
hₖ Height of the glass bottle head segment
hᵣ Height of the glass bottle rolled rim
200 Tube
210 Tube having an open end
220 Conical tube having a conical end
d_{r,a} Tube external diameter
dr,i Tube internal diameter
d_{d,i} Tube nozzle internal diameter
d_{r,a} Tube wall thickness
300 Gas burner
310 Gas flame
BM Base machine
MM Mother machine
A Predetermined spacing of the tube from the filling opening
M Mass flow of the entering purge gas flow 51
AL Axial centerline of the glass bottle
NL Line orthogonal to the centerline ML at the height of the glass bottle filling opening

What is claimed is:

1. A method for producing glass bottles having a flat base and an opposite filling opening, the method comprising the following steps:
locally heating one end of a glass tube;
configuring a flange or a rolled rim having the filling opening at the locally heated end of the glass tube;
severing the locally heated end of the glass tube while configuring a glass bottle having a closed base;
holding the configured glass bottle upside down after severing from the glass tube; and
further forming the base of the glass bottle, wherein in the further forming of the base of the glass bottle a purge gas flow is generated in an interior of the glass bottles with the aid of a purge gas flowing in or out in a centric manner and flowing out or in in an eccentric manner by way of the filling opening.

2. The method of claim 1, wherein the purge gas is blown into the interior of the glass bottle by way of a tube or is suctioned out of the interior of the glass bottle by way of the tube, wherein the tube is a cylindrical tube, and the purge gas is blown in or suctioned out by way of a front end of the tube.

3. The method of claim 2, wherein the cylindrical tube has a conically tapered external profile at the front end.

4. The method of claim 3, wherein the cylindrical tube has a conically tapered internal profile at the front end.

5. The method of claim 3, wherein the cylindrical tube has a portion having a cylindrical internal profile at the front end.

6. The method of claim 3, wherein the cylindrical tube has a portion having a cylindrical external profile at the front end.

7. The method of claim 3, wherein the glass bottles have a filling opening internal diameter d_{g,i}, and the tube has a tube external diameter d_{r,a} as well as a tube internal diameter dr,i, and wherein d_{g,i}²−d_{r,a}²≥d_{r,i}².

8. The method of claim 2, wherein the tube is disposed outside the glass bottle at a predetermined axial spacing from the filling opening.

9. The method of claim 8, wherein the tube is disposed so as to be locationally fixed in relation to the filling opening at the predetermined axial spacing from the filling opening.

10. The method of claim 8, wherein the predetermined axial spacing is in a range between 0.1 mm to 5.0 mm.

11. The method of claim 2, wherein the tube is disposed on a surface, wherein the front end of the tube is disposed at a predetermined spacing from the surface, the predetermined spacing being in a range from 5.0 mm to 15.0 mm.

12. The method of claim 2, wherein the tube by way of the filling opening plunges axially into the glass bottle by a predetermined distance, wherein the tube in the further forming of the base of the glass bottle is axially adjusted in a manner corresponding to a movement path of the glass bottle such that the tube for generating the purge gas flow plunges axially into the glass bottle by the predetermined distance, and for onward transportation of the glass bottle is axially retracted to a position outside the glass bottle, so as to clear the movement path of the glass bottle.

13. The method of claim 12, wherein the tube is disposed in a head region of the glass bottle.

14. The method of claim 12, wherein the tube plunges into a main volume of the glass bottle.

15. The method of claim 1, wherein the purge gas with the aid of a ring nozzle flows eccentrically into the interior of the glass bottle, and is suctioned out of the interior of the glass bottle through a centrically disposed tube.

16. The method of claim 15, wherein the ring nozzle is disposed outside the glass bottle at a predetermined axial spacing from the filling opening, wherein the predetermined axial spacing is in a range between 0.1 mm to 5.0 mm.

17. The method of claim 15, wherein the tube by way of the filling opening plunges axially into the glass bottle by a predetermined distance, wherein the tube in the further forming of the base of the glass bottle is axially adjusted in a manner corresponding to a movement path of the glass bottle such that the tube for generating the purge gas flow axially plunges into the glass bottle by the predetermined distance, and for onward transportation of the glass bottle is axially retracted to a position outside the glass bottle, so as to clear the movement path of the glass bottle.

18. The method of claim 15, wherein an internal diameter d_{r,i} of the tube is at least 1.5 mm.

19. The method of claim 18, wherein a tube external diameter d_{r,a} of the tube meets the correlation d_{r,a}<d_{r,i}−2.0 mm.

20. The method of claim 1, wherein the glass bottles are narrow-neck bottles having a neck internal diameter in the range from 6.0 mm to 13.0 mm and a neck length of at most 12.0 mm.

21. The method of claim 1, wherein the further forming of the base of the glass bottle comprises a plurality of processing steps, wherein a mass flow of the purge gas flow in at least one of the plurality of processing steps is different from the other processing steps.

22. The method of claim 21, wherein the mass flow of the purge gas flow entering the glass bottles is in a range between 2.4 standard liters/min and 20 standard liters/min according to ISO 2533.

23. The method of claim 1, wherein an additional heating output that acts eccentrically is provided at least in portions for compensating an additional cooling effect by virtue of the purge gas flow in the further forming of the base of the glass bottle, the additional heating output comprising an eccentric disposal of a plurality of gas burners which in each case act on the base of the glass bottle.

24. The method of claim 1, wherein an additional heating output that acts centrically on the base of the glass bottle is provided in the further forming of the base of the glass bottle.

25. The method of claim 24, wherein the additional heating output comprises a gas burner and the gas burner generates a gas flame which acts perpendicularly on the base of the glass bottle.

26. The method of claim 1, wherein the purge gas flow is generated in the interior of the glass bottle during the entire further forming of the base of the glass bottle at temperatures between 1000° C. and 1200° C. in the region of the closed base.

27. A method for producing glass bottles having a flat base and an opposite filling opening, the method comprising the following steps:
locally heating one end of a glass tube;
configuring a flange or a rolled rim having the filling opening at the locally heated end of the glass tube;
severing the locally heated end of the glass tube while configuring a glass bottle having a closed base;
holding the configured glass bottle upside down after the severing from the glass tube; and
further forming of the base of the glass bottle, wherein a continuous purge gas flow is generated in an interior of the glass bottle during the entire further forming of the base of the glass bottle at temperatures between 1000° C. and 1200° C. in a region of the closed base with the aid of a purge gas.
